(19) United States
(12) Patent Application Publication
(10) Pub. No.: US 2025/0299114 A1
(43) Pub. Date: Sep. 25, 2025

(54) PROMOTION OF TICKETS FOR EVENT

(71) Applicant: Rakuten Group, Inc., Tokyo (JP)

(72) Inventors: Saki TANAKA, Tokyo (JP); Haruka HORIUCHI, Tokyo (JP); Keisuke TAKAMI, Tokyo (JP)

(73) Assignee: Rakuten Group, Inc., Tokyo (JP)

(21) Appl. No.: 18/861,342

(22) PCT Filed: Dec. 27, 2022
(86) PCT No.: PCT/JP2022/048346

§ 371 Date: Oct. 29, 2024

(51) Int. Cl. G06Q 10/02; H04W 4/021

(52) U.S. Cl. CPC G06Q 10/02; H04W 4/021

(57) ABSTRACT

Provided is a ticket management apparatus having one or more processors, and the one or more processors execute a process including: identifying a cell within a range based on a venue location of an event for which a ticket enables participation therein and corresponding to a time from a current time to a time of the event; acquiring the number of user terminals currently connected to the identified cell; determining whether or not the acquired number of user terminals is equal to or greater than the number of sellable tickets; and when it is determined that the acquired number of user terminals is equal to or greater than the number of sellable tickets, announcing to the user terminals currently connected to the cell that ticket purchase is possible.

### TECHNICAL FIELD

The present disclosure relates to the promotion of tickets for an event.

### BACKGROUND

In general, participants in events such as concerts and sports matches, etc., purchase tickets from an event organizer in advance and present the tickets on the day of the event to enter a venue. In recent years, tickets are issued as electronic tickets and ticket information is stored on a terminal device such as a smartphone that a user carries, etc.

### CITATION LIST

### Patent Literature

Patent Document 1: Japanese Unexamined Patent Application, First Publication No. 2022-137424

### SUMMARY OF INVENTION

### Technical Problem

However, there is a problem in that, for example, when a participant that has purchased a ticket cancels participation in an event, facilities at an event venue go unused due to the cancellation. That is, when a participant cancels and does not go to an event venue, facilities such as a seat for that participant, etc., are not utilized effectively and the organizer of the event also suffers a detriment.

The present disclosure was devised in the light of the foregoing and has an objective of providing a promotion of ticket sales which can achieve effective utilization of the facilities of an event venue.

### Solution to Problem

According to one embodiment of the present disclosure, a ticket management apparatus has one or more processors. The one or more processors execute a process including: identifying cells within a range based on a venue location of an event for which a ticket enables participation therein, the range corresponding to a time from a current time until a time of the event; acquiring the number of user terminals currently connected to the identified cells; determining whether or not the acquired number of user terminals is equal to or greater than the number of sellable tickets; and when it is determined that the acquired number of user terminals is equal to or greater than the number of sellable tickets, announcing to the user terminals currently connected to the cell that ticket purchase is possible.

Further, according to one embodiment of the present disclosure, a sales promotion method includes: identifying a cell within a range based on a venue location of an event for which a ticket enables participation therein, the range corresponding to a time from a current time until a time of the event; acquiring the number of user terminals currently connected to the identified cell; determining whether or not the acquired number of user terminals is equal to or greater than the number of sellable tickets; and when it is determined that the acquired number of user terminals is equal to or greater than the number of sellable tickets, announcing to the user terminals currently connected to the cell that ticket purchase is possible.

### BRIEF DESCRIPTION OF DRAWINGS

FIG. 1 illustrates an example of a sales promotion system according to one embodiment.

FIG. 2 is a block diagram illustrating a configuration of a ticket management apparatus according to one embodiment.

FIG. 3 is a flow diagram illustrating operations of a ticket management apparatus according to one embodiment.

FIG. 4 is a sequence diagram illustrating a sales promotion method according to one embodiment.

FIG. 5 is a block diagram illustrating an example of a hardware configuration of a ticket management apparatus.

### DESCRIPTION OF EMBODIMENTS

Below, one embodiment according to the present disclosure will be described with reference to the attached drawings. The embodiment described below is exemplary and the present disclosure is not to be construed as being limited by this description.

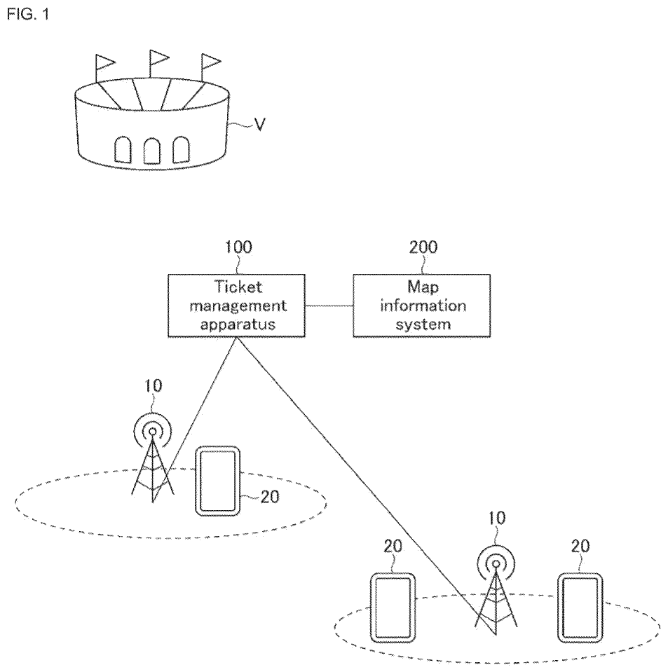

FIG. 1 illustrates an example of a sales promotion system according to one embodiment. The sales promotion system shown in FIG. 1 promotes sales of tickets for an event held at an event venue V and, in particular, promotes sales of surplus tickets generated due to cancellations. This sales promotion system has a ticket management apparatus 100 and a map information system 200, and the ticket management apparatus 100 connects to a mobile network which includes base stations 10 and user terminals (user equipment; hereinafter referred to as “UE”) 20.

The base stations 10 form cells in a range reachable by radio waves and execute wireless communication with the user terminals 20 within the cells. The cells formed by the base stations 10 are each provided with a cell ID which is identification information, and from the cell ID, it is possible to identify a base station 10 forming a respective cell.

When located within a cell formed by a base station 10, the user terminals 20 execute wireless communication with the base station 10 forming that cell. Among these user terminals 20, the user terminal 20 of a participant that is to participate in an event held at the event venue V stores ticket information of a ticket needed to participate in the event. Accordingly, an event participant can, for example, enter the event venue V and participate in the event by presenting the ticket information stored in the user terminal 20.

The ticket management apparatus 100 manages ticket information that the user terminals 20 store. When storing ticket information, the ticket management apparatus 100 associates ticket information of a ticket issued to a user terminal 20 of a participant that has purchased a ticket with identification information of the user terminal 20. In addition, when there are surplus tickets generated due to a cancellation before the start of an event, the ticket management apparatus 100 announces, to user terminals 20 of users that have a high possibility of purchasing tickets, the sale of the surplus tickets. Note that the configuration and operations of the ticket management apparatus 100 will be described in detail later.

The map information system 200 is a system which is capable of storing map information as well as collecting dynamic information such as weather and traffic information, etc., processing map information, and searching for composite information. Examples of such a map information system 200 include a dynamic map system. The map information system 200 receives a request from the ticket management apparatus 100 and searches for cells within a prescribed range centered around the event venue V. At that time, the map information system 200 also searches for weather and traffic information between each cell and the event venue V, and provides notification of weather and traffic information together with a cell search result to the ticket management apparatus 100.

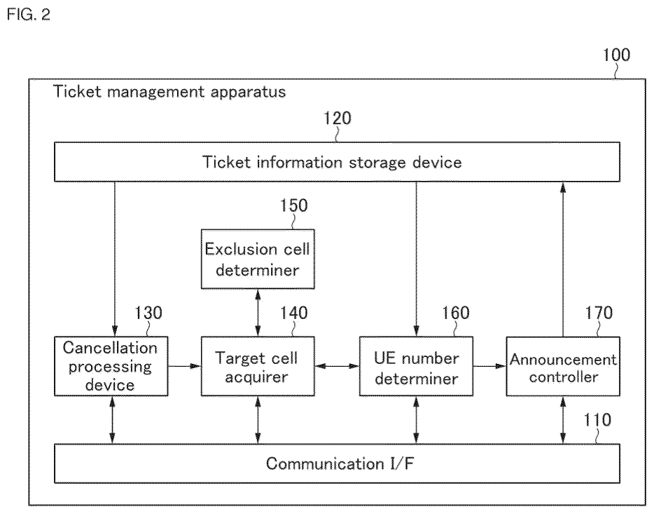

FIG. 2 is a block diagram illustrating a configuration of the ticket management apparatus 100 according to one embodiment. The ticket management apparatus 100 shown in FIG. 2 has a communication interface (hereinafter abbreviated to “communication I/F”) 110, a ticket information storage device 120, a cancellation processing device 130, a target cell acquirer 140, an exclusion cell determiner 150, a UE number determiner 160, and an announcement controller 170.

The communication I/F 110 has an interface for communicating with the base stations 10, the user terminals 20, and the map information system 200, and transmits and receives various kinds of information. Specifically, the communication I/F 110 transmits a search request to request a search for cells within a prescribed range centered around the event venue V, receives a search result from the map information system 200, transmits a report request to report the number of user terminals 20 connected to the base station 10 of each cell, and receives, from the base stations, a report in response to the request.

When storing ticket information, the ticket information storage device 120 associates ticket information of a ticket issued to a user terminal 20 with the identification information of the user terminal 20. That is, when a user purchases a ticket to participate in an event, the ticket information storage device 120 stores the ticket information by associating, with the identification information of the user terminal 20 of that user, ticket information including information such as the date and time that the event will be held, venue, and seat type, etc. Further, when a user cancels participation in an event, the ticket information storage device 120 stores the fact that the ticket information associated with the identification information of the user terminal of that user has been canceled, and stores the fact that a surplus ticket has been generated.

When a cancellation request requesting cancellation of a ticket is received from a user terminal 20 of a user that has purchased a ticket, the cancellation processing device 130 executes a cancellation process to cancel the ticket information associated with that user terminal 20. Note that the cancellation processing device 130 may execute a process such as determining, on the basis of location information of a user terminal 20, whether or not a user is able to arrive at the event venue V by the event start time, and confirming whether or not there will be a cancellation with user terminals 20 for which timely arrival at the event venue V is difficult.

The target cell acquirer 140 transmits, to the map information system 200, a search request to request a search for cells located within a range centered around the event venue V and corresponding to a grace period from a current time until the start of the event. Specifically, the target cell acquirer 140 transmits, to the map information system 200, a search request to request a search for cells included in a circle centered on the event venue V and having a radius corresponding to the grace period. By multiplying the grace period by a prescribed coefficient, for example, the target cell acquirer 140 calculates a distance to the event venue V that it is possible to move during the grace period, and requests a search for cells included in a circle having the calculated value as a radius. The search request transmitted by the target cell acquirer 140 requests a search for cells located within a range and also requests a search for weather and traffic information between the event venue V and each cell in a search result.

In addition, the target cell acquirer 140 acquires, from the map information system 200, a search result corresponding to the search request. That is, the target cell acquirer 140 acquires cell IDs of cells within a prescribed range centered on the event venue V and also acquires weather and traffic information between the event venue V and each cell.

When a cell search result is acquired, the target cell acquirer 140 excludes, from the cells in search result, cells determined as being exclusion cells by the exclusion cell determiner 150, and determines that the remaining cells are target cells which are a ticket sale announcement target. In addition, the target cell acquirer 140 provides notification of the cell IDs of the target cells to the UE number determiner 160.

Further, in line with instructions from the UE number determiner 160, the target cell acquirer 140 transmits, to the map information system 200, a search request to request a search for cells adjacent to the cells already acquired as a search result. That is, the target cell acquirer 140 requests a search for adjacent cells which are adjacent to cells in a range that a search result has already acquired. In addition, the target cell acquirer 140 acquires the cell IDs of adjacent cells which are adjacent to the outer side of an already-searched range, and also acquires weather and traffic information between each cell and the event venue V.

When a cell search result is acquired by the target cell acquirer 140, the exclusion cell determiner 150 refers to the traffic and weather information on routes from each cell to the event venue V, and determines a cell that has an abnormality in weather or traffic circumstances on a route as being an exclusion cell. That is, the exclusion cell determiner 150 determines a cell from which movement to the event venue V during the grace period would be difficult as being an exclusion cell. The exclusion cell determiner 150 transmits the cell IDs of cells determined as being exclusion cells to the target cell acquirer 140.

When notification of the cell ID of a target cell is provided from the target cell acquirer 140, the UE number determiner 160 inquires, of the base station 10 of the target cell, the number of user terminals 20 that are currently connected to the target cell. In addition, the UE number determiner 160 acquires, from the ticket information storage device 120, the number of surplus tickets generated due to cancellations (hereinafter referred to as “cancellation number”), and compares the cancellation number and the total number of user terminals 20 that are currently connected to the target cell (hereinafter referred to as “connected UE number”).

When the connected UE number is equal to or greater than the cancellation number, the UE number determiner 160 provides notification of the cell ID of the target cell to the announcement controller 170. Further, when the connected UE number is less than the cancellation number, the UE number determiner 160 instructs the target cell acquirer 140 to search for cells adjacent to the searched cell. That is, when the connected UE number is small relative to the cancellation number, the UE number determiner 160 provides an instruction to search for adjacent cells in order to expand the target cell to adjacent cells. In addition, for a target cell expanded to adjacent cells, the UE number determiner 160 again acquires a connected UE number and compares the connected UE number and the cancellation number.

When notification of the cell ID of a target cell is provided from the UE number determiner 160, the announcement controller 170 causes a confirmation message to be transmitted from the base station 10 of the target cell to a user terminal 20 in the target cell to confirm whether or not the user terminal 20 is registered as a user terminal 20 that can purchase a ticket. That is, the announcement controller 170, for example, broadcasts, to a user terminal 20 in a target cell, a confirmation message to confirm whether or not an application for purchasing tickets is installed. In addition, the announcement controller 170 transmits an announcement message to announce that purchase of tickets is possible to a user terminal 20 which, in response to the confirmation message, replies that registration has been carried out. Furthermore, for a user terminal 20 which, in response to the announcement message, replies that purchase of a tickets is desired, the announcement controller 170 executes a sale process to sell a ticket, and stores the ticket information in the ticket information storage device 120.

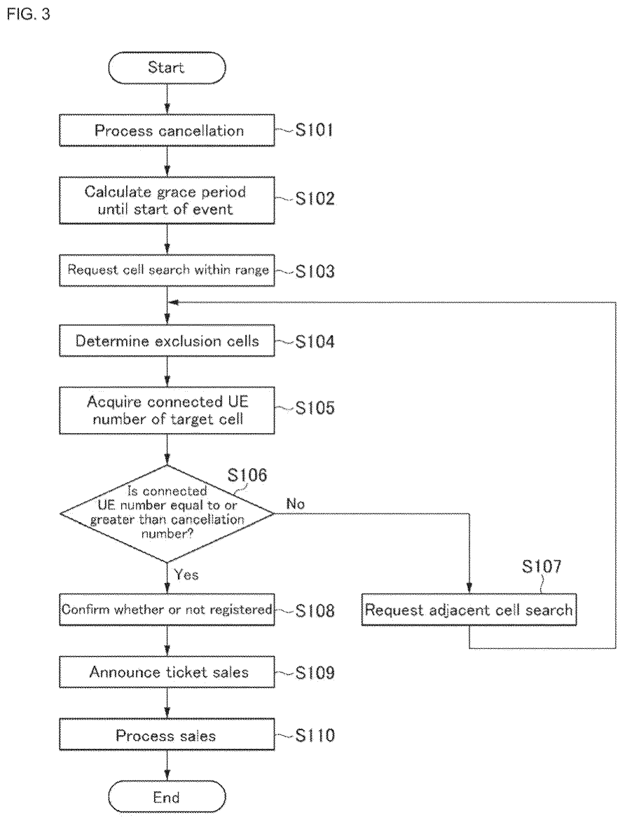

Next, a ticket management method by the ticket management apparatus 100 configured as described above shall be explained with reference to the flow diagram shown in FIG. 3.

Before the start of an event, ticket information is associated with identification information of user terminals 20 of users that purchased tickets for an event and is stored in the ticket information storage device 120 of the ticket management apparatus 100. When a cancellation request requesting cancellation of a ticket is received from these user terminals 20, the cancellation processing device 130 executes a cancellation process to cancel the ticket information associated with the user terminals 20 (step S101). Surplus tickets generated due to cancellations can be ascertained from the ticket information storage device 120, and the cancellation number can be acquired by referring to the ticket information storage device 120.

When a cancellation process is executed by the cancellation processing device 130, the target cell acquirer 140 calculates a grace period from the current time until the start of the event (step S102). In addition, at a timing at which the grace period becomes a prescribed time, a search request is transmitted to the map information system 200 to request a search for cells located within a range centered around the event venue V and corresponding to the grace period (step S103). Specifically, by multiplying the grace period by a prescribed coefficient, for example, a distance to the event venue V that it is possible to move during the grace period is calculated, and a search for cells included in a circle having the calculated value as a radius is requested.

The map information system 200 receives the search request and searches for cells within the specified range. Further, the map information system 200 searches for weather and traffic information on routes from each cell in the search result to the event venue V, and transmits the weather and traffic information along with the cell IDs of the cells in the search result to the ticket management apparatus 100.

The target cell acquirer 140 of the ticket management apparatus 100 acquires the search result, and the exclusion cell determiner 150 determines whether or not there are exclusion cells in the cells in the search result (step S104). Specifically, weather and traffic information on routes from each cell in the search result to the event venue V is referred to and a cell that has an abnormality in weather or traffic circumstances on a route is determined as being an exclusion cell. In addition, the target cell acquirer 140 excludes the exclusion cell from cells in the search result and determines that the remaining cells are target cells which are a ticket sale announcement target. Thus, by excluding, from target cells, cells from which movement to the event venue V is difficult, it is possible to exclude, from the ticket sale target, users for which participation in the event is difficult. Notification of the cell IDs of the target cells is provided to the UE number determiner 160.

When notification of the cell IDs of the target cells is provided, the UE number determiner 160 executes an inquiry, to the base station 10 of each target cell, as to the number of user terminals 20 that are currently connected. Upon receiving a reply from each base station 10 regarding the number of user terminals 20 currently connected, the UE number determiner 160 calculates the total number of user terminals 20 currently connected to the target cells (connected UE number), and compares the connected UE number and the cancellation number (step S106). That is, a cancellation number is acquired from the ticket information storage device 120, and a determination is made as to whether or not the connected UE number is equal to or greater than the cancellation number.

When the result of this determination is that the connected UE number is less than the cancellation number (step S106 No), in order to enlarge the target cell and increase the connected UE number, the target cell acquirer 140 is instructed to search for adjacent cells. In addition, the target cell acquirer 140 transmits, to the map information system 200, a search request to request a search for adjacent cells which are adjacent to cells already obtained as a search result (step S107). Specifically, a search for adjacent cells which are adjacent to the outer side of an already-searched range is requested.

The map information system 200 receives the search request and searches for the specified adjacent cells. Further, the map information system 200 searches for weather and traffic information on routes from each adjacent cell in the search result to the event venue V, and transmits the weather and traffic information along with the cell IDs of the cells in the search result to the ticket management apparatus 100.

The adjacent cell search result is acquired by the target cell acquirer 140 of the ticket management apparatus 100, and in the same manner as when cells within a range centered around the event venue V were searched for, a determination is made as to whether or not there are exclusion cells (step S104), exclusion cells are excluded, and the remaining adjacent cells are included in the target cells. In addition, the connected UE number of the target cells is acquired (step S105), and the UE number determiner 160 again compares the connected UE number and the cancellation number (step S106).

When the result of the determination of step S106 is that the connected UE number is equal to or greater than the cancellation number (step S106 Yes), notification of the cell IDs of the target cells is provided to the announcement controller 170. In addition, the announcement controller 170 broadcasts, to the user terminals 20 located in the target cells, a confirmation message to confirm whether or not registration as a user terminal 20 that can purchase tickets is complete (step S108). This confirmation message may confirm, for example, whether or not an application for purchasing tickets is installed.

Upon acquiring answers from user terminals 20 in response to the confirmation message, the announcement controller 170 transmits, to registered user terminals 20, an announcement message to announce that purchase of tickets is possible (step S109). in addition, when there is an answer that ticket purchase is desired from a user terminal 20, the announcement controller 170 executes a sale process to sell a ticket (step S110), and stores the ticket information in the ticket information storage device 120.

Thus, a cell in a location from which movement to the event venue V during the grace period until the start of the event is possible is determined as being a target cell, and a ticket sales announcement is made to the user terminals 20 located in the target cell. Due thereto, the possibility that a ticket is purchased can be raised to sell many surplus tickets, and by increasing the number of participants in the event, it is possible to achieve effective utilization of the facilities of the event venue V.

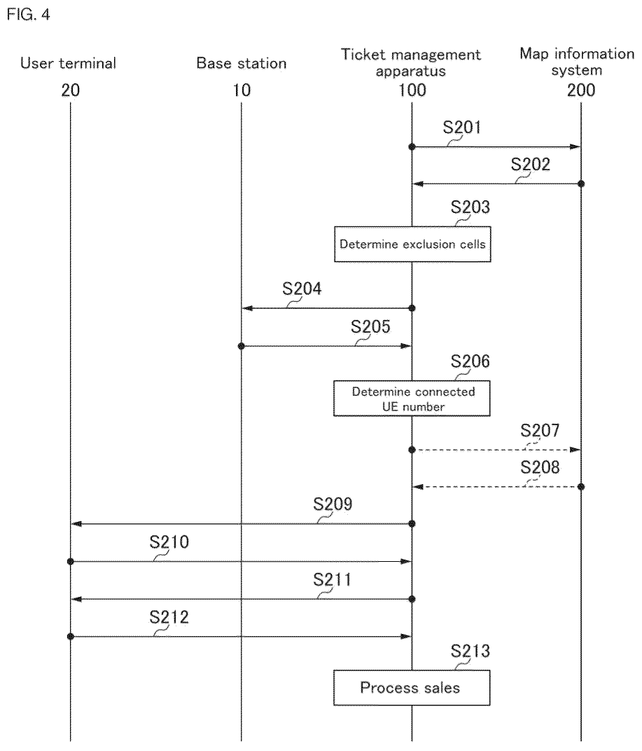

FIG. 4 is a sequence diagram illustrating a sales promotion method in the sales promotion system described above.

When a grace period until the start of an event becomes a prescribed time, the ticket management apparatus 100 transmits, to the map information system 200, a search request to request a search for cells located within a range centered around the event venue V and corresponding to the grace period (step S201). The ticket management apparatus 100, for example, sets a movable distance per unit time as a coefficient and requests a search for cells located within a circle having, as a radius, a distance obtained by multiplying the grace period by the coefficient. The map information system 200 that receives the search request searches for cells within the specified range and also searches for weather and traffic information on routes from each cell to the event venue V. In addition, the map information system 200 transmits, to the ticket management apparatus 100, a search result including the cell IDs of the cells and the weather and traffic information obtained by the search (step S202).

Upon receiving the search result, the ticket management apparatus 100 refers to the weather and traffic information on routes from each cell to the event venue V and determines whether or not there are exclusion cells (step S203). That is, for a cell having an abnormality in weather or traffic circumstances on a route to the event venue V, it is considered that it would be difficult to move to the event venue V during the grace period, and therefore, such a cell is determined as being an exclusion cell to be excluded from the target cell. In addition, the ticket management apparatus 100 inquires, of the base stations 10 of the target cells remaining after the exclusion cells have been excluded from the cells in the search result, the number of user terminals 20 currently connected (step S204). The base station 10 of each target cell reports, to the ticket management apparatus 100, the number of user terminals 20 located in a cell formed by that base station 10 (step S205).

When the number of user terminals 20 currently connected is reported from the respective base stations 10 of the target cells, the ticket management apparatus 100 calculates the connected UE number by totaling the number of user terminals 20. In addition, the ticket management apparatus 100 compares the connected UE number and the number of surplus tickets generated due to cancellations (cancellation number), and determines whether or not, as an announcement target, there is a sufficient number of user terminals 20 currently connected to the target cells (step S206).

When the result of this determination is that the connected UE number is less than the cancellation number, in order to increase the connected UE number, the ticket management apparatus 100 transmits, to the map information system 200, a search request to request a search for adjacent cells which are adjacent on the outer side of an already-searched range (step S207). The map information system 200 searches for the specified adjacent cells and also searches for weather and traffic information on routes from each adjacent cell to the event venue V. In addition, the map information system 200 transmits, to the ticket management apparatus 100, a search result including the cell IDs of the adjacent cells and the weather and traffic information obtained by the search (step S208). When the adjacent cell search result is received, too, the ticket management apparatus 100 determines the target cells by excluding exclusion cells from the adjacent cells in the search result, inquires, of the base stations 10, the number of user terminals 20 currently connected to the target cells, and compares the connected UE number and the cancellation number. In addition, the ticket management apparatus 100 adds adjacent cells to expand the target cells until the connected UE number is equal to or greater than the cancellation number.

When the connected UE number becomes equal to or greater than the cancellation number, the ticket management apparatus 100 broadcasts, via the base stations 10 of the target cells, a confirmation message to confirm whether or not registration as a user terminal 20 that can purchase tickets is complete (step S209). The confirmation message may confirm, for example, whether or not an application for purchasing tickets is installed in a user terminal 20. The user terminals 20 that receive the confirmation message reply, to the ticket management apparatus 100, as to whether or not registration is complete (step S210). Alternatively, there may be a configuration wherein only registered user terminals 20 reply to the confirmation message.

The ticket management apparatus 100 transmits, to the registered user terminals 20, an announcement message to announce that purchase of tickets is possible (step S211). The user terminals 20 that receive the announcement message reply to the ticket management apparatus 100 with an answer indicating whether or not the purchase of tickets is desired (step S212). The ticket management apparatus 100 executes a sale process to sell tickets to the user terminals 20 for which the purchase of tickets is desired (step S213).

As described above, according to the present embodiment, cells in locations from which movement to an event venue by the start of the event is possible and having a total number of user terminals currently connected that is equal to or greater than the number of surplus tickets are determined as being target cells, and the sale of surplus tickets is announced to the user terminals located in the target cells. Due thereto, the possibility that a ticket is purchased can be raised so that many surplus tickets are sold, and by increasing the number of participants in the event, it is possible to achieve effective utilization of the facilities of the event venue V.

Note that in the embodiment described above, it was assumed that the UE number determiner 160 inquires, of the base stations 10 of the target cells, the number of user terminals 20 currently connected, and compares the cancellation number and the total number of user terminals 20 currently connected to the target cells (connected UE number). However, the UE number determiner 160 does not necessarily have to compare the connected UE number and the cancellation number.

The UE number determiner 160 may, for example, multiply the connected UE number by a propagation rate of an application for purchasing tickets, and compare the cancellation number and a user terminal number obtained by the foregoing multiplication. The propagation rate of an application is a proportion, among all of the user terminals 20, of user terminals 20 which have the application installed therein. A propagation rate estimated in advance may be used. Further, a proportion of the user terminals 20 which reply to the confirmation message broadcast by the announcement controller 170 that registration is complete may be used as a propagation rate of an application.

Further, when an edge apparatus such as an edge cloud or edge server, etc., that manages the cells of respective base stations 10, for example, is connected to a base station 10, the UE number determiner 160 may acquire, from the edge apparatus, the number of user terminals 20, among the user terminals 20 currently connected to the target cells, that have installed therein an application for purchasing tickets. In that case, the UE number determiner 160 compares the cancellation number and the total number of user terminals 20 which are currently connected to the target cells and have completed installation of the application.

By performing the foregoing, it is possible to determine the target cells such that the number of user terminals 20 that are actually capable of purchasing tickets is equal to or greater than the cancellation number, and it is possible to promote the sale of surplus tickets more efficiently.

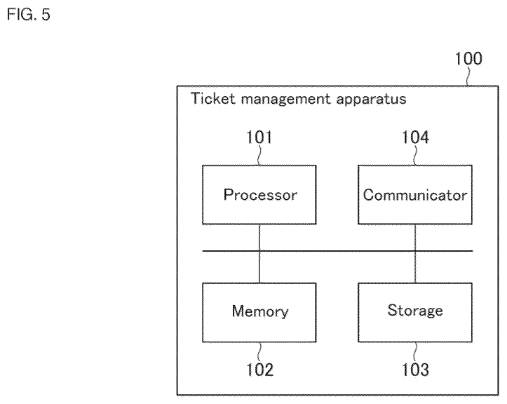

The ticket management apparatus 100 according to the embodiment described above may be configured by using a processor and a memory. FIG. 5 is a block diagram illustrating an example of a hardware configuration of the ticket management apparatus 100 according to one embodiment. As illustrated in FIG. 6, the ticket management apparatus 100 includes a processor 101, a memory 102, a storage 103, and a communicator 104.

The processor 101 includes, for example, a Central Processing Unit (CPU), a Field Programmable Gate Array (FPGA), a Digital Signal Processor (DSP), or the like, performs integrated control of the entire the ticket management apparatus 100, and also executes various kinds of information processing.

The memory 102 includes, for example, a Random Access Memory (RAM) or a Read Only Memory (ROM), etc., and stores information to be used in information processing executed by the processor 101.

The storage 103 includes, for example, a Hard Disk Drive (HDD) or a Solid State Drive (SSD), etc., and stores various kinds of data.

The communicator 104 includes an interface for executing wired communication or wireless communication and communicates with the base stations 10 and the map information system 200.

Note that the ticket management apparatus 100 may, for example, have other configurations not shown, such as a display or an operation switch, etc.

The processing by the ticket management apparatus 100 explained in the embodiment above may also be described as a program that can be executed by a computer. In that case, this program can be stored on a computer-readable non-transitory recording medium and installed onto a computer. Examples of such a recording medium include portable recording media such as CD-ROMs, DVD disks, USB memories, etc., and semiconductor memories such as flash memories, etc.

Note that the present disclosure is not limited to the above embodiment and includes various modified examples in which constituent elements have been added, removed, or replaced with respect to the configurations described above.

The present disclosure described above includes the following (1) to (6).
(1) A ticket management apparatus having one or more processors,
wherein the one or more processors execute a process including:
   identifying a cell within a range based on a venue location of an event for which a ticket enables participation therein, the range corresponding to a time from a current time until a time of the event;
   acquiring the number of user terminals currently connected to the identified cell;
   determining whether or not the acquired number of user terminals is equal to or greater than the number of sellable tickets; and
   when it is determined that the acquired number of user terminals is equal to or greater than the number of sellable tickets, announcing to the user terminals currently connected to the cell that ticket purchase is possible.
(2) The ticket management apparatus described in (1) above,
wherein the identifying includes
   among the cells which are within the range, identifying, on the basis of weather or traffic circumstances on a route to the venue of the event, cells from which is excluded a cell having an abnormality in weather or traffic conditions on the route to the venue of the event.
(3) The ticket management apparatus described in (1) or (2) above,
wherein the acquiring includes
   inquiring, of a base station forming the identified cell, the number of user terminals currently connected to the cell.
(4) The ticket management apparatus described in (1) or (2) above,
wherein the acquiring includes
   acquiring the number of user terminals in which the number of user terminals currently connected to the identified cell is multiplied by a propagation rate indicating a proportion of user terminals that are capable of purchasing tickets.
(5) The ticket management apparatus described in (1) or (2) above,
wherein the acquiring includes
   acquiring, from an edge apparatus which manages the identified cell, the number of user terminals which are currently connected to the cell and are capable of purchasing tickets.
(6) A sales promotion method including:
   identifying a cell within a range based on a venue location of an event for which a ticket enables participation therein, the range corresponding to a time from a current time until a time of the event;
   acquiring the number of user terminals currently connected to the identified cell;
   determining whether or not the acquired number of user terminals is equal to or greater than the number of sellable tickets; and
   when it is determined that the acquired number of user terminals is equal to or greater than the number of sellable tickets, announcing to the user terminals currently connected to the cell that ticket purchase is possible.

### REFERENCE SIGNS LIST

10 Base station
20 User terminal
100 Ticket management apparatus
101 Processor
102 Memory
103 Storage
104 Communicator
110 Communication I/F
120 Ticket information storage device
130 Cancellation processing device
140 Target cell acquirer
150 Exclusion cell mine
160 UE number determiner
170 Announcement roller
200 Map

1. A ticket management apparatus having one or more processors,
wherein the one or processors execute a process comprising:
identifying a cell within a range based on a venue location of an event for which a ticket enables participation therein, the range corresponding to a time from a current time until a time of the event;
acquiring the number of user terminals currently connected to the identified cell;
determining whether or not the acquired number of user terminals is equal to or greater than the number of sellable tickets; and
when it is determined that the acquired number of user terminals is equal to or greater than the number of sellable tickets, announcing to the user terminals currently connected to the cell that ticket purchase is possible.

2. The ticket management apparatus according to claim 1,
wherein the identifying comprises
among the cells which are within the range, identifying, on the basis of weather or traffic circumstances on a route to the venue of the event, cells from which is excluded a cell having an abnormality in weather or traffic conditions on the route to the venue of the event.

3. The ticket management apparatus according to claim 1,
wherein the acquiring comprises
inquiring, of a base station forming the identified cell, the number of user terminals currently connected to the cell.

4. The ticket management apparatus according to claim 1,
wherein the acquiring comprises
acquiring the number of user terminals in which the number of user terminals currently connected to the identified cell is multiplied by a propagation rate indicating a proportion of user terminals that are capable of purchasing tickets.

5. The ticket management apparatus according to claim 1,
wherein the acquiring comprises
acquiring, from an edge apparatus which manages the identified cell, the number of user terminals which are currently connected to the cell and are capable of purchasing tickets.

6. A sales promotion method comprising:
identifying, using a processor, a cell within a range based on a venue location of an event for which a ticket enables participation therein, the range corresponding to a time from a current time until a time of the event;
acquiring, using the processor, the number of user terminals currently connected to the identified cell;
determining, using the processor, whether or not the acquired number of user terminals is equal to or greater than the number of sellable tickets; and
when it is determined that the acquired number of user terminals is equal to or greater than the number of sellable tickets, announcing, using the processor, to the user terminals currently connected to the cell that ticket purchase is possible.
